(19) United States
(12) Patent Application Publication
(10) Pub. No.: US 2023/0080428 A1
(43) Pub. Date: Mar. 16, 2023

(54) OVERHEAD-STRUCTURE RECOGNITION DEVICE

(71) Applicant: DENSO CORPORATION, Kariya-city (JP)

(72) Inventor: Masanari TAKAGI, Kariya-city (JP)

(21) Appl. No.: 18/050,898

(22) Filed: Oct. 28, 2022

Related U.S. Application Data
(63) Continuation of application No. PCT/JP2021/017137, filed on Apr. 30, 2021.

(30) Foreign Application Priority Data
May 1, 2020 (JP) 2020-081326

(51) Int. Cl. G01S 17/931; G01S 17/42; G01S 17/87; B60W 30/14; B60W 40/04

(52) U.S. Cl. CPC G01S 17/931; B60W 30/146; B60W 40/04; G01S 17/42; G01S 17/87; B60W 2420/42; B60W 2420/52; B60W 2554/20; B60W 2556/20

(57) ABSTRACT

In an overhead-structure recognition device to be mounted to a vehicle, a determination unit is configured to, in response to a vertical distance between an object of interest and a high-reflectivity object being greater than or equal to a predefined value of vertical distance, determine that the object of interest is an overhead structure which is a structure located above the vehicle that does not obstruct travel of the vehicle. The object of interest corresponds to a subset of interest among a plurality of subsets acquired by dividing range point cloud data. The high-reflectivity object is an object other than the object of interest, among objects corresponding to the respective subgroups, whose reflectance is greater than or equal to a predefined value of reflectance.

### CROSS-REFERENCE TO RELATED APPLICATION

This application is a continuation application of International Application No. PCT/JP2021/017137 filed Apr. 30, 2021 which designated the U.S. and claims priority to Japanese Patent Application No. 2020-081326 filed with the Japan Patent Office on May 1, 2020, the contents of each of which are incorporated herein by reference.

### BACKGROUND

### Technical Field

This disclosure relates to an overhead-structure recognition device.

### Related Art

An overhead-structure recognition device is known that uses a LIDAR device and a millimeter-wave radar device to recognize an overhead structure which is a structure located above a vehicle carrying the object recognition device and does not obstruct travel of the vehicle. The object recognition device calculates a horizontal relative speed between the vehicle and an object of interest using LIDAR, and compares the calculated relative speed with a relative speed between the vehicle and the object of interest, detected by millimeter waves, thereby determining whether the object of interest is an overhead structure.

### BRIEF DESCRIPTION OF THE DRAWINGS

In the accompanying drawings:

FIG. 1A is a schematic diagram illustrating a configuration of an onboard device according to one embodiment;

FIG. 1B is a functional block diagram of a LIDAR ECU;

FIG. 1C is a functional block diagram of an ADAS ECU;

FIG. 2A is a side view illustrating emission of laser light according to the embodiment;

FIG. 2B is a plan view illustrating emission of laser light according to the embodiment;

FIG. 3 is a flowchart of overhead-structure recognition processing performed by an overhead-structure recognition device;

FIG. 4 is an illustration of a process of increasing the likelihood of an overhead structure according to the embodiment;

FIG. 5 is an illustration of an extraction region for high-reflectivity objects according to the embodiment; and

FIG. 6 is a flowchart of overhead-structure determination processing performed by the overhead-structure recognition device according to the embodiment.

### DESCRIPTION OF SPECIFIC EMBODIMENTS

As to the above known overhead-structure recognition device as disclosed in JP 2019-2769 A, for example, in a case where an overhead structure is located ahead of and horizontally facing the vehicle due to its location on a downhill slope, the relative speed detected by millimeter waves may be equal to the relative speed in the horizontal direction calculated using LIDAR or the like. In such a case, the presence or absence of an overhead structure may not be determined accurately.

One aspect of the present disclosure provides an overhead-structure recognition device to be mounted to a vehicle including an acquisition unit, a subdivision unit, and a determination unit. The acquisition unit is configured to, based on received reflected light of laser light emitted from the vehicle in each of a plurality of directions whose angles with respect to a vertical direction are different from each other, acquire range point cloud data including a plurality of pieces of range point data, each of the plurality of pieces of range point data being tuple data of a distance variable indicating a distance between the vehicle and an object reflecting the laser light, a reflectance variable indicating a reflectance of the object, and a distance variable indicating a direction in which the laser hight was emitted. The subdivision unit is configured to, based on the distance variable and the direction variable of each of the pieces of range point data constituting the range point cloud data, subdivide the range point cloud data into a plurality of subsets such that a distance between any pair of positions corresponding to pieces of rage point data belonging to a respective one of the plurality of subsets, from which the laser light was reflected, is less than or equal to a predefined value of distance. The determination unit is configured to, based on the reflectance variable, in response to a vertical distance between an object of interest and a high-reflectivity object being greater than or equal to a predefined value of vertical distance, the object of interest corresponding to a subset of interest among the plurality of subsets, the high-reflectivity object being an object other than the object of interest, among objects corresponding to the respective subgroups, whose reflectance is greater than or equal to a predefined value of reflectance, determine that the object of interest is an overhead structure which is a structure located above the vehicle that does not obstruct travel of the vehicle.

With this configuration, focusing on the vertical distance between an object of interest and a high-reflectivity object located near the road surface allows a determination as to whether the object of interest is an overhead structure to be made with high accuracy.

Hereinafter, an overhead-structure recognition device according to one embodiment of the present disclosure will be described in detail with reference to the accompanying drawings, in which like reference numerals refer to similar elements and duplicated description thereof will be omitted.

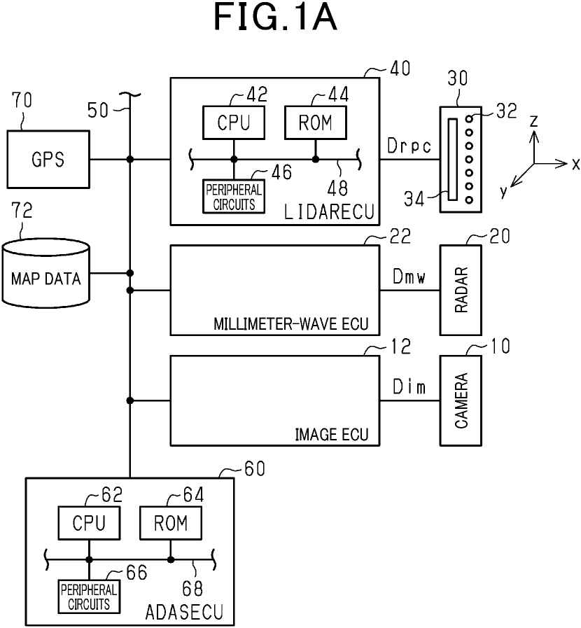

FIG. 1 illustrates an overhead-structure recognition device to be mounted to a vehicle VC according to the present embodiment. As illustrated in FIG. 1, image data Dim that is data regarding images captured by a camera 10 is input to an image ECU 12. ECU is an abbreviation for electronic control unit. The image ECU 12 recognizes objects around the vehicle VC based on the image data Dim. This recognition processing includes determining whether an object detected around the vehicle VC is an overhead structure located above the vehicle VC that does not impede travel of the vehicle VC. Here, the overhead structure may be a sign, a signboard, a bridge or the like.

A millimeter-wave radar device 20 transmits millimeter-wave radar waves to the surroundings of the vehicle VC and receives the millimeter-wave radar waves reflected from an object around the vehicle VC, and thereby outputs signals regarding a distance and a relative speed between the vehicle VC and the object that reflected the millimeter-wave radar, as millimeter-wave data Dmw. The millimeter wave data Dmw is forwarded to the millimeter-wave ECU 22. Based on the millimeter-wave data Dmw, the millimeter-wave ECU 22 performs recognition processing of an object around the vehicle VC. This recognition processing includes a determination process of determining whether the object detected based on the millimeter-wave data Dmw is an overhead structure.

Based on emitting laser light, such as near-infrared light or the like, and receiving its reflected light, a LIDAR device 30 generates range point data indicating a distance variable indicating a distance between the vehicle and the object that reflected the laser light, a direction variable indicating a direction in which the laser light was emitted, and a reflection intensity of the object that reflected the laser light. The reflection intensity, which is a physical quantity that indicates the intensity of the received light, indicates the reflectance of the object that reflected the laser light in conjunction with the distance variable. That is, the range point data may be regarded as tuple data composed of the distance variable, the direction variable, and the reflectance variable that is a variable indicating the reflectance of the object that reflected the laser light.

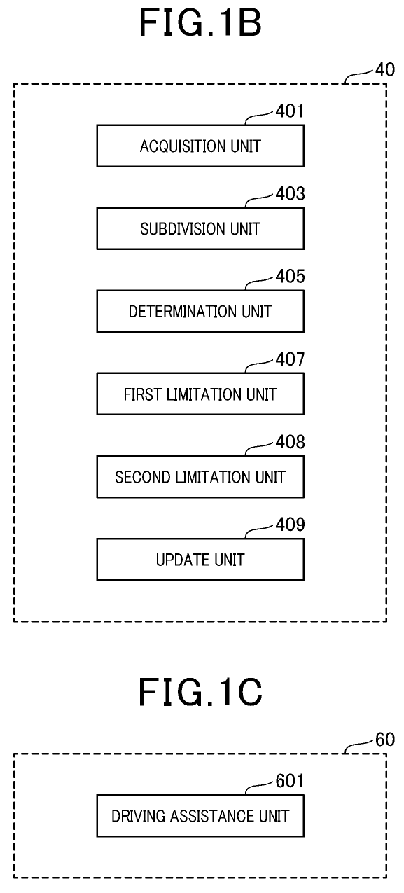

Specifically, the LIDAR 30 device includes a plurality of light emitting elements 32 arranged along the z-direction that is orthogonal to each of the x-direction (i.e., longitudinal direction) of the vehicle VC and the y-direction (i.e., lateral direction) of the vehicle VC. Angles of optical axes of the respective light emitting elements 32 with the z-direction are different from each other. This means that angles made by the optical axes of the respective light emitting elements 32 with the vertical direction are different from each other. In the following, the upward direction of the vehicle is defined to be a positive direction of the z-axis. FIG. 2A illustrates the optical axes OP1-OP7 of the laser light emitted from the respective light emitting elements 32.

The LIDAR device 30 horizontally scans laser light by emitting the laser light while shifting the optical axis of each light emitting element 32 in the y-direction with the angle fixed between the optical axis of the light emitting element 32 and the z-direction. FIG. 2B illustrates an example of horizontally scanning the laser light along the optical axis OP3. In FIG. 2B, the optical axis OP(1) and the optical axis OP(2) are adjacent to each other in the horizontal direction. The optical axes OP3 (1), OP3 (2), OP3 (3),... are lines in a plane defined by a corresponding fixed angle with respect to the z-direction. Similarly, when horizontally scanning the laser light along each of the optical axes OP1, OP2, OP4-OP7, each optical axis is a line in a plane defined by a corresponding fixed angle with respect to the z-direction. That is, when horizontally scanning the laser light along each of the seven optical axes OP1-OP7, each optical axis lies in one of the seven planes whose angles with respect to the z-direction are different from each other.

Returning to FIG. 1, in the LIDAR device 30, a control operation unit 34 horizontally scans the laser light emitted in seven directions having different angles with respect to the vertical direction, from the light emitting elements 32, and generates range point cloud data Drpc based on reflected light of the emitted laser light. The range point cloud data Drpc includes range point data for each of the seven directions having different angles with respect to the vertical direction and for each of horizontally different directions.

In the present embodiment, since a low-resolution LIDAR device 30 with a relatively small number of optical axes OP1-OP7 having different angles with respect to the z-axis is used, which of the optical axes the range point data is based on reflected light of the laser light along is particularly important in expressing vertical position information of the object that reflected the laser light. Therefore, in the present embodiment, each of pieces of range point data that constitute the range point cloud data is classified according to which of the optical axes OP1-OP7 the piece of range point data is based on emission of the laser light along. In detail, each of pieces of range point data that constitute the range point cloud data Drpc is classified according to which of the seven planes mentioned above the piece of range point data is based on, where each of the seven planes includes optical axes acquired by horizontally shifting a corresponding one of the optical axes OP1-OP7. Specifically, each of pieces of range point data that constitute the range point cloud data is classified by assigning an identification symbol to each of the seven planes.

In the present embodiment, the time-of-flight (TOF) method is exemplified as a method for calculating the distance variable. In the present embodiment, a plurality of beams of laser light having different optical axes are not to be emitted at the same timing such that timings of receiving the beams of laser light having different optical axes can be reliably distinguished from each other. In the present embodiment, a dedicated hardware circuit, such as an application specific integrated circuit (ASIC) or the like, that performs laser beam emission control and a generation process of generating the range point cloud data Drpc is exemplified as the control operation unit 34.

A LIDAR ECU 40 performs recognition processing of an object that reflected the laser light based on the range point cloud data Drpc. This recognition processing includes a determination process of determining whether the object recognized based on the range point cloud data Drpc is an overhead structure. In detail, the LIDAR ECU 40 includes a CPU 42, a ROM 44, and peripheral circuits 46, which are communicable with each other via a local network 48. The peripheral circuits 46 include a circuit that generates clock signals to define internal operations, a power supply circuit, a reset circuit, and other circuits. The LIDAR ECU 40 performs the recognition processing by the CPU 42 executing a program stored in the ROM 44.

The image ECU 12, the millimeter-wave ECU 22, and the LIDAR ECU 40 are communicable with the ADAS ECU 60 via an in -vehicle network 50. ADAS is an abbreviation for advanced driver assistance system. The ADAS ECU 60 performs a process of assisting a user in driving the vehicle VC. In the present embodiment, driving assistance on a limited highway, such as so-called adaptive cruise control for controlling travel of the vehicle VC to achieve a target vehicle speed while giving priority to keeping a distance from the vehicle VC to a forward vehicle at or above a predefined value, is exemplified. The ADAS ECU 60 performs a process of generating a final object recognition result to be finally referred to for driving assistance, based on results of object recognition by the image ECU 12, the millimeter wave ECU 22, and the LIDAR ECU 40. The ADAS ECU 60 refers to position data from the global positioning system (GPS) 70 and map data when generating the final object recognition result.

The ADAS ECU 60 includes a CPU 62, a ROM 64, and peripheral circuits 66, which are communicable with each other via a local network 68.

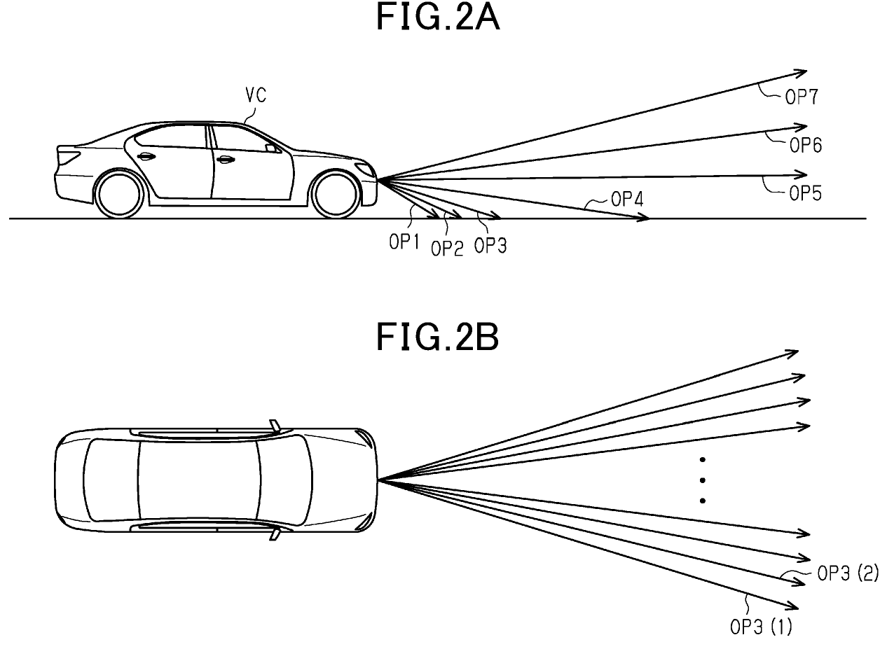

FIG. 3 illustrates a procedure for overhead structure recognition processing performed by the LIDAR ECU 40 according to the present embodiment. The overhead structure recognition processing illustrated FIG. 3 is implemented by the CPU 42 repeatedly performing the program stored in the ROM 44 every cycle the range point cloud data Drpc is generated. In the following, each step is represented by a number with the prefix “S”.

In the sequence of process steps illustrated in FIG. 3, the CPU 42 first acquires the range point cloud data Drpc (at S10). Next, the CPU 42 performs a clustering process (at S12) based on the range point cloud data Drpc. In the present embodiment, the following procedure is exemplified as the clustering process.
(a) The CPU 42 generates a bird’s-eye view by projecting points that reflected the laser light onto the xy-plane based on the distance and direction variables indicated by each piece of range point data of the range point cloud data Drpc.
(b) After excluding points corresponding to a road surface from the points projected onto the xy-plane, the CPU 42 classifies some of remaining points, a distance between any pair of points of which is less than or equal to a predefined value, into the same subset. Furthermore, any pair of points, of the remaining points, with a z-directional distance therebetween greater than a predefined value, belong to different subsets.

Each of subsets thus acquired is assumed to correspond to an object that reflected the laser light.

Then, the CPU 42 sets one of objects corresponding to the subsets generated in the clustering process, as an object of interest AO(i) (at S14). The object of interest AO(i) is an object to be determined as to whether it is an overhead structure.

The CPU 42 then determines whether the absolute speed V of the object of interest AO(i) is lower than or equal to a predefined speed (at S16). This is a determination step of determining whether an overhead structure condition is met. In detail, the CPU 42 calculates a relative speed of the object of interest AO(i) relative to the vehicle VC based on a position of the object of interest AO(i) based on the range point cloud data Drpc acquired in the previous cycle of the overhead structure recognition processing illustrated in FIG. 3 and a position of the object of interest AO(i) based on the ranging point group data Drpc acquired in the current cycle. The absolute speed V is then calculated by adding the vehicle speed of the vehicle VC to the relative speed. At the first timing when the object of interest AO(i) is detected, the absolute speed V may be a certain speed that is greater than a predefined speed.

If determining that the absolute speed V is lower than or equal to the predefined speed (“YES” branch of step S16), the CPU 42 classifies pieces of range point data corresponding to the object of interest AO(i) into the above-described seven planes whose angles with respect to the z-direction are different from each other and acquires the most frequent symbol MID that is an identification symbol of the plane with the largest number of pieces of range point data among those seven planes (at S18).

The CPU 42 determines whether a distance L between the object of interest AO(i) and the vehicle VC is greater than or equal to a threshold Lth (at S20). Here, the threshold Lth is variably set according to the most frequent symbol MID such that the smaller the angle between the optical axis corresponding to the plane indicated by the most frequent symbol MID and the positive direction of the z-axis in FIG. 1, the smaller the threshold Lth.

This step is a determination step of determining whether a vertical distance between the vehicle VC and the object of interest AO(i) is greater than or equal to a specified value Hth.

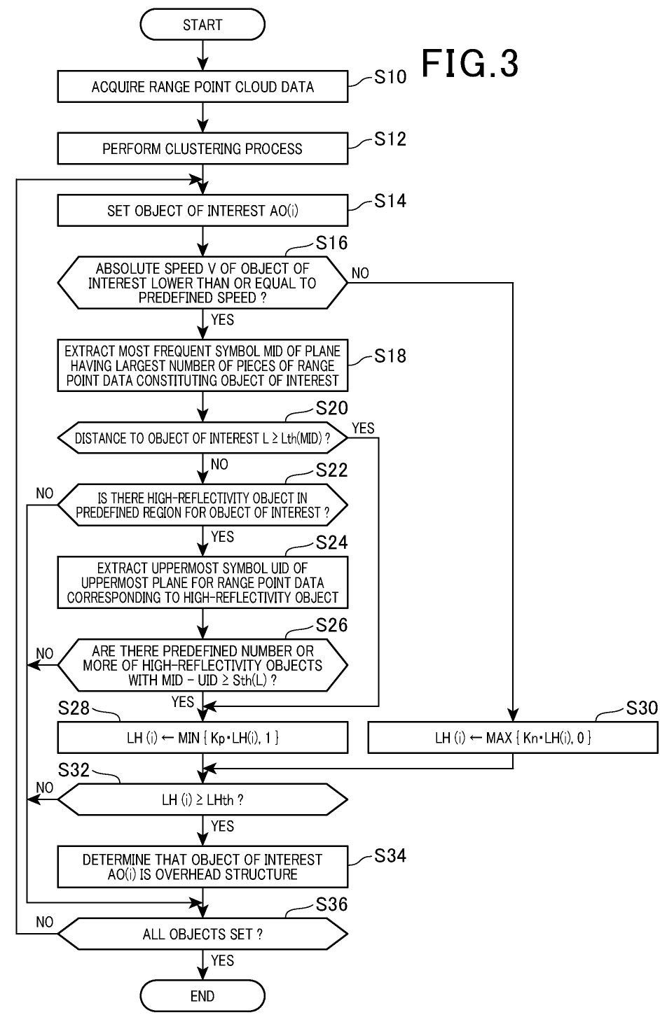

That is, as illustrated in FIG. 4, the plane corresponding to the optical axis OP7 has a smaller angle with respect to the positive direction of the z-axis in FIG. 1 than the plane corresponding to the optical axis OP6, which means that the vertical height increases despite there being a shorter distance from the vehicle VC. In other words, despite there being a shorter distance from the vehicle VC, the lower limit (specified value Hth) of the assumed vertical distance from a road surface at a location where an overhead structure, such as a sign, a signboard, a bridge or the like, is disposed is easier to reach. Therefore, setting the above threshold Lth to a smaller value for a smaller angle made by the optical axis with the positive direction of the z-axis allows it to be determined whether the vertical distance between the vehicle VC and the object of interest AO(i) is greater than or equal to the specified value Hth.

Returning to FIG. 3, if the distance L between the object of interest AO(i) and the vehicle VC is less than the threshold Lth (“NO” branch of S20), the CPU 42 determines whether there is a high-reflectivity object having the reflectance greater than or equal to a predefined value, within a predefined region for the object of interest AO(i) (at S22). This step is a determination step of determining whether there is a piece of range point data with the reflectance greater than or equal to the predefined value, in pieces of range point data belonging to the subgroups other than the object of interest AO(i), among the subgroups classified by the clustering process. Whether the reflectance is greater than or equal to the predefined value is determined by whether the reflection intensity of the range point data is greater than or equal to a criterion value. The criterion value is set to a smaller value as the distance to the vehicle VC increases. This can be implemented, for example, by the CPU 42 performing map calculation of the criterion value with map data prestored in the ROM 44, including the distance to the vehicle VC as an input variable and the criterion value as an output variable. The map data is tuple data of discrete values of the input variable and values of the output variable corresponding to the values of the input variable. In the map calculation, for example, if a value of the input variable matches one of the values of input variable in the map data, the value of the output variable in the corresponding map data is used as a calculation result, whereas if the value of the input variable does not match any one of the values of the input variable in the map data, a value acquired by interpolation between plural values of the output variable in the map data may be used as a calculation result. In the present embodiment, the specified number is greater than or equal to two.

In the present embodiment, the above predefined value defining a high-reflectivity object is set based on the reflectance of a reflector that is a reflective member of a vehicle.

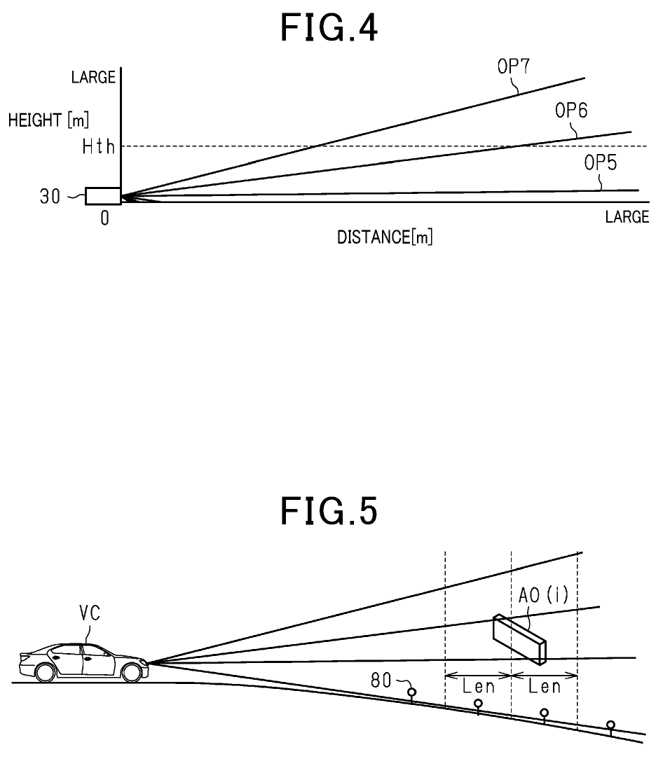

As illustrated in FIG. 5, the predefined region is defined such that a distance from the object of interest AO(i) in the x-direction is less than or equal to a specified value Len and a distance from the object of interest AO(i) in the y-direction is less than or equal to a specified value Sid. The specified value Len may be, for example, a value within a range of 20 to 30 m. The specified value Sid may be, for example, a value within a range of 8 to 12 m. Preferably, the specified value Len may be greater than or equal to half a spacing of delineators 80.

Returning to FIG. 3, if it is determined that there is a high-reflectivity object (“YES” branch of S22), the CPU 42 extracts the uppermost symbol UID that is an identification symbol of the uppermost plane for the range point data corresponding to the high-reflectivity object (at S24). For example, if the plane corresponding to optical axis OP7 and the plane corresponding to optical axis OP6 both have range point data corresponding to the high-reflectivity object, the plane corresponding to optical axis OP7 is the uppermost plane. The identification symbol of the plane corresponding to the optical axis OP7 is the uppermost symbol UID. The process at S24 is a process to regard the subsets classified by the clustering process as separate high-reflectivity objects, and in a case where there are a plurality of high-reflectivity objects, identify the uppermost symbol UID for each of the respective high-reflectivity objects.

Subsequently, the CPU 42 determines whether there are a predefined number or more of high-reflectivity objects with a value acquired by subtracting the uppermost symbol UID from the most frequent symbol MID of the object of interest AO(i) being greater than or equal to a threshold value Sth (at S26). This process is a process of determining whether the vertical distance between the object of interest AO(i) and the high-reflectivity object is greater than a predefined value. In the present embodiment, the identification symbol corresponding to the optical axis OPk is “k” (k = 1 to 7), among the planes each generated by horizontally scanning the optical axis with the angle to the vertical direction fixed. Therefore, for example, if the most frequent symbol MID indicates the plane corresponding to optical axis OP7 and the uppermost symbol UID indicates the plane corresponding to optical axis OP5, the subtracted value is “2” (= MID - UID). The CPU 42 sets the threshold value Sth to a smaller value when the distance L between the object of interest AO(i) and the vehicle is large, as compared to when the distance L is small.

If determining that there are the predefined number or more high-reflectivity objects (“YES” branch of S26), then the CPU 42 updates the likelihood LH(i) of the object of interest AO(i) being an overhead structure to 1 or LH(i) multiplied by a specific coefficient Kp greater than 1, whichever is smaller (at S28). If the likelihood LH(i) multiplied by the specific coefficient Kp greater than 1 is equal to 1, then the CPU 42 substitutes 1 into the likelihood LH(i). The initial value of the likelihood LH is ½.

If the absolute speed V of the object of interest AO(i) is higher than the predefined speed (“NO” branch of S16), then the CPU 42 updates the likelihood LH(i) of the object of interest AO(i) being an overhead structure to 0 or the likelihood LH(i) multiplied by a specific coefficient Kn greater than 0 and less than 1, whichever is larger (at S30). If the likelihood LH(i) multiplied by the specific coefficient Kn greater than 0 and less than 1 is equal to 0, then the CPU 42 substitutes 0 into the likelihood LH(i).

Upon completion of the process at S28 or S30, the CPU 42 determines whether the likelihood LH(i) is greater than or equal to a criterion value LHth (at S32). If it is determined that the likelihood LH(i) is greater than or equal to the criterion value LHth (“YES” branch of S32), the CPU 42 determines that the object of interest A O(i) is an overhead structure (at S34).

If the process at S34 has been completed or if the answer is NO at S22, S26 or S32, the CPU 42 determines whether all of the subsets classified in the clustering process have been set as the object of interest AO (at S36). If there is a subset that has not yet been set as the object of interest AO (“NO” branch of S36), the CPU 42 returns to S14 and sets the object corresponding to that subset as the object of interest AO. The CPU 42 then changes the variable “i” specifying the object of interest AO(i).

If it is determined that all subsets have been set as the object of interest AO(i) (“YES” branch of S36), the CPU 42 terminates the sequence of process steps illustrated in FIG. 3.

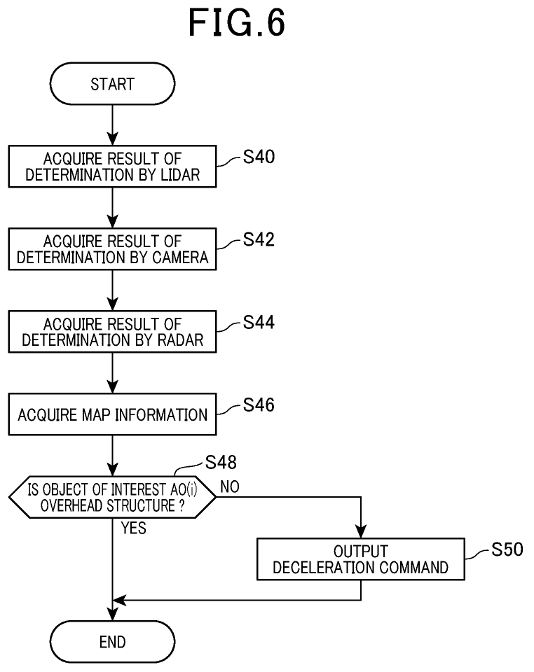

FIG. 6 illustrates a procedure for the ADAS ECU 60 to finally determine an overhead structure. The process flow illustrated in FIG. 6 is implemented by the CPU 62 repeatedly performing the program stored in ROM 64 every predefined cycle.

In the sequence of process steps illustrated in FIG. 6, the CPU 62 first acquires the result of determination by the LIDAR ECU 40, the result of determination by the image ECU 12, and the result of determination by the millimeter-wave ECU 22, regarding the determination as to whether the object of interest AO(i) is an overhead structure and some determinations to be used for the same determination, at S40-S44. Subsequently, the CPU 42 acquires information regarding the slope of a road surface on which the vehicle VC is traveling, and whether there is an overhead structure, such as a bridge ahead or the like, based on position data from the GPS 70 and map data 72 (S46). Then, based on the acquired information and each acquired determination result, the CPU 62 determines whether the object of interest AO(i) is an overhead structure (S48). If it is determined that the object of interest AO(i) is not an overhead structure (“NO” branch of S48), the CPU 62 outputs a deceleration command to decelerate the vehicle VC by operating the brake actuator (S50). If the process at S50 has been completed or if the answer is YES at S48, the CPU 42 terminates the sequence of process steps illustrated in FIG. 6.

As illustrated in FIG. 1B, the LIDAR ECU 40 includes, as functional blocks, an acquisition unit 401 responsible for execution of step S10 of the overhead-structure recognition processing illustrated in FIG. 3, a subdivision unit 403 responsible for execution of step S12 of the overhead-structure recognition processing, a determination unit 405 responsible for execution of steps S26-S34 of the overhead-structure recognition processing, a first limitation unit 407 responsible for execution of step S16 of the overhead-structure recognition processing, a second limitation unit 408 responsible for execution of step S22 of the overhead-structure recognition processing and an update unit 409 responsible for execution of steps S20 and S28 of the overhead-structure recognition processing. Functions of these blocks are implemented by the CPU 42 reading the program(s) from a non-transitory, tangible, computer-readable storage medium (or a non-transitory memory), i.e., the ROM 44, and executing these programs using a RAM (not shown) as a work area.

As illustrated in FIG. 1C, the ADAS ECU 60 includes, as a functional block, a driving assistance unit 601 responsible for execution of steps S40-S50 of the overhead-structure determination processing illustrated in FIG. 6. The function of this block is implemented by the CPU 62 reading the program(s) from a non-transitory, tangible, computer-readable storage medium (or a non-transitory memory), i.e., the ROM 64, and executing this program using a RAM (not shown) as a work area.

The functions and advantages of the present embodiment will now be described.

In response to there being a high-reflectivity object within the predefined region for the object of interest AO(i), the CPU 42 determines whether the vertical distance between the high-reflectivity object and the object of interest AO(i) is greater than or equal to the predetermined value (at S26). In response to determining that the vertical distance between the high-reflectivity object and the object of interest AO(i) being greater than or equal to the predetermined value, the CPU 42 increases the likelihood LH (i) of the object of interest AO(i) being an overhead structure. The high-reflectivity object with a low absolute speed V may be an object having a predefined height, such as a delineator, a rear portion of a preceding vehicle. Therefore, in a case where the vertical distance between the high-reflectivity object and the object of interest AO(i) is greater than or equal to the predetermined value, it may be determined that the object of interest AO(i) is likely to be an overhead structure.

In this way, focusing on the vertical distance between the object of interest AO(i) and a high-reflectivity object having a low absolute speed allows a determination as to whether the object of interest AO(i) is an overhead structure to be made with high accuracy, even on a downhill slope or the like as illustrated in FIG. 5. However, during travel on a downhill slope or the like as illustrated in FIG. 5, use of the process at S20 alone may lead to the “NO” answer. Thus, the object of interest AO(i) may not be recognized to be likely to be an overhead structure.

The present embodiment described above can further provide the following advantages.

Quantifying a height of a high-reflectivity object using the uppermost symbol UID allows the vertical distance between the high-reflectivity object and the object of interest, AO(i) to be determined with high accuracy. That is, for example, in a case where the high reflectivity object is a delineator, which is a pillar with a reflector provided thereon, the position of the reflector is specified. Therefore, the uppermost symbol UID is a highly accurate indicator of the height of the high reflectivity object.

The object of interest AO(i) to be determined as to whether it is an overhead structure is limited to those whose absolute speed is lower than or equal to a predefined speed. This allows signboards, a sign, a pole or the like to be recognized as an overhead structure with high accuracy.

The high-reflectivity object subjected to determination as to its vertical distance to the object of interest AO(i) is limited to those whose horizontal distance to the object of interest AO(i) is within the predefined distance. Even when the vehicle VC is approaching a downhill, this may lead to the vertical distance between the object of interest AO(i) and the high-reflectivity object being greater than or equal to the predefined value in a case where the object of interest AO(i) is an overhead structure.

That is, as illustrated in FIG. 5, when the vehicle VC is approaching a downhill, even if the object of interest AO(i) is actually an overhead structure, a certain delineator 80 as a high-reflectivity object that is too far away from the object of interest AO(i) and close to the vehicle VC may have a small vertical distance to the object of interest AO(i). As such, setting the predefined region so as to increase the accuracy of determination as to whether the object of interest AO(i) is an overhead structure based on a greater or smaller vertical distance between the object of interest AO(i) and the high reflectivity object can increase the likelihood of the YES answer in the process at S26 when the object of interest AO(i) is an overhead structure.

Provided that there are a plurality of high-reflectivity objects whose vertical distance to the object of interest AO(i) is greater than or equal to the predefined value, the likelihood LH(i) of the object of interest AO(i) being an overhead structure is increased. This can prevent the accuracy of determination as to whether to increase the likelihood LH (i) from decreasing due to noise or other effects.

That is, in a case where pieces of range point data corresponding to points where the vertical distance to the object of interest AO(i) is greater than or equal to the predefined value are points strongly effected by noise, it may be determined that the vertical distance to the object of interest AO(i) is greater than or equal to the predetermined value, despite the object of interest AO(i) not being an overhead structure. However, requiring that the number of high-reflectivity objects whose vertical distance to the object of interest AO(i) is greater than or equal to the predefined value is greater than one can suppress the increase in the likelihood LH (i) when the object of interest AO(i) is not an overhead structure.

In addition, determining whether to increase the likelihood LH(i) of the object of interest AO(i) being an overhead structure regardless of the number of high-reflectivity objects whose vertical distance from the object of interest AO(i) is less than the predetermined value can prevent the situation from occurring where the likelihood LH (i) is not increased despite the object of interest AO(i) being an overhead structure. That is, even in a case where there are a large number of high-reflectivity objects whose vertical distance to the object of interest AO(i) is less than the predetermined value due to a plurality of signboards being provided and recognized as high-reflectivity objects, this allows the likelihood LH (i) to be increased when the object of interest AO(i) is an overhead structure.

Even in a case where there are less than the predefined number of high-reflectivity objects whose vertical distance to the object of interest AO(i) is greater than or equal to the predefined value, the likelihood LH (i) of the object of interest AO(i) being an overhead structure is not to be decreased. This can preferably prevent the situation from occurring where the likelihood LH (i) of the object of interest AO(i) being an overhead structure is decreased despite the object of interest AO(i) being an overhead structure. That is, for example, in a case where there are no delineators or the like while a plurality of signboards are provided, these signboards may be recognized as high reflectivity objects. In such a case, when decreasing the likelihood LH (i) of the object of interest AO(i) being an overhead structure based on there being less than the predefined number of high-reflectivity objects whose vertical distance to the object of interest AO(i) is greater than or equal to the predefined value, the likelihood LH (i) of the object of interest AO(i) being an overhead structure may be decreased despite the object of interest AO(i) being an overhead structure.

When quantifying the vertical distance between the object of interest AO(i) and the high-reflectivity object or the vehicle, the height of the object of interest AO(i) is quantified by the plane with the largest number of range point data constituting the object of interest AO(i). For example, even if the signboard is supported by a pillar and pieces of range point data corresponding to the reflected light from the pillar and signboard are considered to belong to the same subset, this allows the vertical distance between the object of interest AO(i) and the high-reflectivity object or the vehicle to be determined.

In response to the likelihood LH(i) being greater than or equal to the criterion value LHth, the object of interest AO(i) is determined to be an overhead structure. Even though either only the “YES” determination at S20 or only the “YES” determination at S26 does not lead to a high likelihood of the object of interest AO(i) being an overhead structure, the accuracy of the process at S34 may be improved.

Regardless of the vertical height between the high-reflectivity object and the vehicle, when the vertical distance between the object of interest AO(i) and the vehicle is greater than or equal to the specified value Hth, the likelihood LH (i) of the object of interest AO(i) being an overhead structure is increased. This can prevent the situation from occurring where the process at S50 is performed even in a case where the object of interest AO(i) is an overhead structure.

The final determination as to whether the object of interest AO(i) is an overhead structure, which is to be referred to when performing driving assistance, is made by the CPU 62 using, in addition to the result of determination by the LIDAR ECU 40, the result of determination by the image ECU 12, the result of determination by the millimeter-wave ECU 22, and information regarding the map data 72. Using sensor fusion in this way allows a more accurate determination as to whether the object of interest AO(i) is an overhead structure to be made.

(10) An object reflecting the laser light, the reflectance of which is greater than or equal to the predefined value, is determined to be a high-reflectivity object, where the predefined value defining the high-reflectivity object is set based on the reflectance of a reflector of a vehicle. The reflector of the vehicle is one whose reflectance is defined within a certain range and whose vertical distance from a road is also within a certain range. This allows a vertical distance of the object of interest AO(i) from a road to be determined with high accuracy.

### Other Embodiments

The present embodiment may be implemented with the following modifications. The present embodiment and the following modifications may be implemented in combination with each other to the extent that they are technically consistent.

Regarding Process based on height difference from object of interest
(A1) The determination process of determining whether the vertical distance between the vehicle VC and the object of interest AO(i) is greater than or equal to the specified value Hth is not limited to the process at S20. For example, this determination process may be a process of comparing a value acquired by multiplying the sine of an angle between the plane with the largest number of pieces of range point data corresponding to the object of interest and the horizontal plane by the distance L with a threshold value. Here, the threshold value may be set to a value greater than or equal to the above specified value Hth.
(A2) The determination process of determining whether the vertical distance between the vehicle VC and the object of interest AO(i) is greater than or equal to the specified value Hth is not limited to the process using only the pieces of range point data associated with the plane with the largest number of pieces of range point data corresponding to the object of interest. For example, this determination process may be a process of determining whether the average difference between the height indicated by all pieces of range point data constituting the object of interest AO(i) and the height at which the vehicle VC is located is greater than or equal to a criterion value. Here, the criterion value is set by taking into account the effect on the height of the object of interest AO(i) due to the low height indicated by the range point data corresponding to the light reflected from the pillar supporting the signboard or the like.

Regarding reflectance of high-reflectivity object:

(A3) In the present embodiment, the high-reflectivity object is an object having the reflectance greater than or equal to the predefined value, where the predefined value is set based on the reflectance of a reflector of a vehicle. Alternatively, for example, the predefined value may be set based on the reflectance of a reflective member of the delineator. The reflective member may not be limited to those of the delineator, but may be any member whose vertical distance from a road is within a predefined relatively low range and whose reflectance is defined by a standard.

Regarding determination process based on vertical distance between object of interest and high-reflectivity object:
(A4) The determination process of determining whether the vertical distance between the object of interest and the high-reflectivity object is greater than or equal to the predefined value is not limited to the process at S24. For example, heights of the high-reflectivity object and the object of interest may be calculated, and whether the difference between them is greater than or equal to a predefined value may be determined. Here, the height of the high-reflectivity object may be calculated by the product of a distance indicated by pieces of range point data on the uppermost plane, among the pieces of range point data corresponding to the high-reflectivity object, and the sine of an angle between the uppermost plane and the horizontal plane. In a case where there are a plurality of distances indicated by pieces of range point data on the uppermost plane, among the pieces of range point data corresponding to the high-reflectivity object, the average or maximum of the plurality of distances may be used. The height of the object of interest may be calculated by the product of a distance indicated by pieces of range point data on the plane with the largest number of pieces of range point data corresponding to the object of interest and the sine of an angle between the plane with the largest number of pieces of range point data and the horizontal plane. In a case where there are a plurality of distances indicated by pieces of range point data on the plane with the largest number of pieces of range point data, the average or maximum of the plurality of distances may be used.
(A5) The determination process of determining whether the vertical distance between the vehicle VC and the object of interest AO(i) is greater than or equal to the predefined value is not limited to the process using only the pieces of range point data associated with the uppermost plane, among pieces of range point data corresponding to the high-reflectivity object, and the pieces of range point data associated with the plane with the largest number of pieces of range point data corresponding to the object of interest. For example, the height of the object of interest is the average of heights indicated by the pieces of range point data corresponding to the object of interest. This determination process may be a process of determining whether the height difference between the high-reflectivity object and the object of interest is less than or equal to a predefined value.

Regarding process of updating likelihood:
(A6) As illustrated in FIG. 3, in a case where the answer is NO at S16, the likelihood LH(i) of the object of interest AO(i) being an overhead structure is reduced by a predefined amount under the condition that LH(i) is kept at or above zero. Alternatively, for example, the process flow may return to S14 and change the object of interest AO(i).
(A7) In the above embodiment, the amount of update in updating the likelihood is determined based on predefined fixed values of specific coefficients Kp and Kn. Alternatively, the amount of update may be variably set according to a condition under which an update is to be made. For example, the amount of update of the likelihood may be greater in a case where the answer is YES at S26 than in a case where the answer is YES at S20. In such an embodiment, in a case where the answer is NO at S26, the likelihood LH(i) of the object of interest AO(i) being an overhead structure may be decreased by an amount of update whose absolute value is less than an amount by which the likelihood LH(i) is increased at S28.
(A8) The determination process of determining whether the object of interest AO(i) is an overhead structure is not limited to the process of determining that the object of interest AO(i) is an overhead structure in response to the likelihood LH(i) of the object of interest AO(i) being greater than or equal to the threshold value LHth. For example, a discriminant function may be used that receives the result of determination at each of the processes at S20 and S26 as input and outputs a result of determination as to whether the object of interest AO(i) is an overhead structure.
(A9) It is not imperative to perform the determination process of determining whether the object of interest AO(i) is an overhead structure based only on the range point cloud data Drpc output by the LIDAR 30. For example, a discriminant function may be used that receives, in addition to the result of determination by each of the processes at S20 and S26, feature amounts extracted from image data Dim, feature amounts extracted from millimeter-wave data output by the millimeter-wave radar device 20, and feature amounts extracted from map data 72 as input and outputs a result of determination as to whether the object of interest AO(i) is an overhead structure.

Regarding speed limitation:
(A10) It is not imperative to perform the process of limiting the object of interest subjected to a determination as to whether it is an overhead structure to an object whose speed is lower than the predefined speed.
(A11) It is not imperative to perform the process of limiting the high-reflectivity object subjected to determination as to whether its vertical distance to the object of interest is greater than or equal to the predefined value to an object whose distance to the object of interest is within the predefined distance.

Regarding LIDAR device:

(A12) In the above embodiment, the LIDAR device 30 having seven directions whose angles with respect to the vertical direction are different from each other is exemplified. It is not imperative to provide a separate light emitting element for each of directions whose angles with respect to the vertical direction are different from each other. For example, a single light emitting element may scan laser light not only in the horizontal direction but also in the vertical direction. Alternatively, the LIDAR device 30 is not limited to a LIDAR device scanning the laser light in the horizontal direction, but may be a flash LIDAR.

Regarding LIDAR ECU:

(A13) In the above embodiment, the LIDAR device 30 and the LIDAR ECU 40 are separate devices that are communicable with each other. Alternatively, the LIDAR device 30 and the LIDAR ECU 40 may be integrated into a single device.

Regarding overhead-structure recognition device:
(A14) In the above embodiment, the ADAS ECU 60 performs the final determination as to whether the object of interest is an overhead structure with reference to the map data 72, but it is not imperative to refer to the map data 72.
(A15) The overhead-structure recognition device set forth above is configured to include the LIDAR ECU 40, the millimeter-wave ECU 22, the image ECU 12, and the ADAS ECU 60. Alternatively, the overhead-structure recognition device may be configured to include the LIDAR ECU 40 and the image ECU 12 but not include the millimeter-wave ECU 22, or may be configured to include the LIDAR ECU 40 and the millimeter-wave ECU 22 but not include the image ECU ECU 12. Still alternatively, the overhead-structure recognition device may be configured to include only the LIDAR ECU 40, where the ADAS ECU 60 may be configured to perform driving assistance based only on results of determination by the LIDAR ECU 40.
(A16) The overhead structure recognition device is not limited to those including the CPU and the ROM to perform software processing. For example, at least part of what is software processed in the above embodiment may be provided in a dedicated hardware circuit (e.g., ASIC or the like) that performs hardware processing. That is, the overhead-structure recognition device may be in any one of the following configurations (a) through (c).
   (a) The overhead-structure recognition device may include at least one software execution device formed of a processing unit and a program storage device (e.g., a ROM or the like), that executes all of the above processes according to one or more programs stored in the program storage device.
   (b) The overhead-structure recognition device may include at least one software execution device formed of a processing unit and a program storage device, that executes some of the above processes according to one or more programs, and at least one dedicated hardware circuit that performs the rest of the processes.
   (c) The overhead-structure recognition device may include at least one dedicated hardware circuit that performs all of the above processes.

In any one of the above configurations (a)-(c), the at least one software execution device may include a plurality of software execution devices, and the at least one dedicated hardware circuit may include a plurality of dedicated hardware circuits.

Regarding driving assistance process:

(A17) The driving assistance process is not limited to a deceleration process in which a braking actuator is to be operated. For example, the driving assistance process may be a process of outputting an audio signal to alert the driver by operating a speaker. In short, the driving assistance process may be a process of operating a specific electronic device for driving assistance. Others:

(A18) The method of measuring a distance to an object reflecting the laser light is not limited to the TOF method. For example, it may be a method using the FMCW or AMCW.

Although the present disclosure has been described in accordance with the above-described embodiments, it is not limited to such embodiments, but also encompasses various variations and variations within equal scope. In addition, various combinations and forms, as well as other combinations and forms, including only one element, more or less, thereof, are also within the scope and idea of the present disclosure.

What is claimed is:

1. An overhead-structure recognition device for a vehicle, comprising:
an acquisition unit configured to, based on received reflected light of laser light emitted from the vehicle in each of a plurality of directions whose angles with respect to a vertical direction are different from each other, acquire range point cloud data including a plurality of pieces of range point data, each of the plurality of pieces of range point data being tuple data of a distance variable indicating a distance between the vehicle and an object reflecting the laser light, a reflectance variable indicating a reflectance of the object, and a distance variable indicating a direction in which the laser hight was emitted;
a subdivision unit configured to, based on the distance variable and the direction variable of each of the pieces of range point data constituting the range point cloud data, subdivide the range point cloud data into a plurality of subsets such that a distance between any pair of positions corresponding to pieces of rage point data belonging to a respective one of the plurality of subsets, from which the laser light was reflected, is less than or equal to a predefined value of distance; and
a determination unit configured to, based on the reflectance variable, in response to a vertical distance between an object of interest and a high-reflectivity object being greater than or equal to a predefined value of vertical distance, the object of interest corresponding to a subset of interest among the plurality of subsets, the high-reflectivity object being an object other than the object of interest, among objects corresponding to the respective subgroups, whose reflectance is greater than or equal to a predefined value of reflectance, determine that the object of interest is an overhead structure which is a structure located above the vehicle that does not obstruct travel of the vehicle.

2. The overhead-structure recognition device according to claim 1, wherein
the determination unit is configured to, in response to the subset indicating the high-reflectivity object including the pieces of range point data based on reflected light of the laser light emitted in two or more directions whose angles with respect to the vertical direction are different from each other, determine whether the vertical distance between the object of interest and the high-reflectivity object is greater than or equal to the predefined value of vertical distance, by selectively using the pieces of range point data corresponding to an upwardmost direction of the two or more directions.

3. The overhead-structure recognition device according to claim 1, further comprising:
a first limitation unit configured to limit the object of interest to be determined as to whether it is an overhead structure, to those whose speed is lower than or equal to a predefined speed.

4. The overhead-structure recognition device according to claim 1, further comprising:
a second limitation unit configured to limit the high-reflectivity object subjected to determination as to whether its vertical distance to the object of interest is greater than or equal to the predefined value of vertical distance to a high-reflectivity object whose horizontal distance to the object of interest is within a predefined distance.

5. The overhead-structure recognition device according to claim 1, further comprising:
an update unit configured to repeatedly determine whether the vertical distance between the object of interest and the high-reflectivity object is greater than or equal to the predefined value of vertical distance, and each time it is determined that the vertical distance between the object of interest and the high-reflectivity object is greater than or equal to the predefined value of vertical distance, increase a likelihood of the object of interest being an overhead structure, thereby updating the likelihood, wherein the determination unit is configured to, in response to the likelihood being greater than or equal to a criterion value, determine that the object of interest is the overhead structure.

6. The overhead-structure recognition device according to claim 5, wherein the determination unit is configured to, in response to the vertical distance between the object of interest and the high-reflectivity object is less than the predefined value of vertical distance, keep the likelihood unchanged.

7. The overhead-structure recognition device according to claim 5, wherein the update unit is configured to, regardless of whether the vertical distance between the object of interest and the high-reflectivity object is greater than or equal to the predefined value of vertical distance, increase the likelihood in response to a vertical distance between the object of interest and the vehicle being greater than or equal to a specified value.

8. The overhead-structure recognition device according to claim 7, wherein the update unit is configured to, in response to the subset of interest indicating the object of interest including the pieces of range point data based on reflected light of the laser light emitted in two or more directions whose angles with respect to the vertical direction are different from each other, determine whether a vertical distance between the object of interest and the vehicle is greater than or equal to the specified value, by selectively using the pieces of range point data corresponding to one of the two or more directions, to which the largest number of pieces of range point data correspond.

9. The overhead-structure recognition device according to claim 1, further comprising:
a driving assistance unit configured to, based on the range point cloud data, determine whether the object of interest is an overhead structure by taking into account not only a result of determination by the determination unit, but also signals other than the received reflected laser light, including at least one of a signal indicating an image of surroundings of the vehicle, a signal regarding reflected waves arising from emission of millimeter waves from the vehicle, and a signal indicating map information at a location of the vehicle.

10. The overhead-structure recognition device according to claim 1, wherein the predefined value of reflectance defining the reflectance of the high-reflectivity object is set based on a reflectance of a reflective member specified by a prescribed standard, which is present on a road.
